(19) United States
(12) Patent Application Publication
(10) Pub. No.: US 2007/0100760 A1
(43) Pub. Date: May 3, 2007

(54) System and method for selling work machine projects

(75) Inventor: Jay Ronald Dawson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/261,574

(22) Filed: Oct. 31, 2005

(51) Int. Cl. G06Q 99/00; H04L 9/00

(52) U.S. Cl. 705/52

(57) ABSTRACT

Systems and methods are disclosed for selling work machine projects. According to one embodiment, a method of selling projects performable by work machines is disclosed and includes receiving, at a processing device, one or more predefined parameters indicative of a proposed work project. The method also includes determining, based on the predefined parameters provided by a user, one or more equipment solutions for performing the project, using at least one work machine. The method further includes calculating a fee associated with the one or more equipment solutions based on a predetermined usage characteristic. The method also includes providing the at least one work machine associated with the determined equipment solution to the user. The method further includes remotely monitoring one or more operational aspects of the at least one work machine during operations of the work project.

### TECHNICAL FIELD

This application relates generally to selling services of industrial equipment and, more particularly, to a system and method for marketing projects performable by a work machine.

### BACKGROUND

Work machines such as, for example, wheel loaders, motor graders, track-type tractors, dump trucks, and other types of machinery are used to perform a variety of tasks associated with an industry such as, mining, construction, manufacturing, transportation, or any other such industry. In certain situations, these machines are owned by companies that employ the machines as part of their business operations. However, in an effort to reduce costly overhead associated with the operation and maintenance of the work machines, many companies lease or rent these machines from equipment rental firms that own and maintain the work machines. Furthermore, renting or leasing work machines allows companies to select machines equipped with the latest, most productive, and most fuel efficient technology available, thereby increasing productivity and reducing overhead operational costs. Thus, in certain circumstances, renting or leasing of work machine equipment may provide a cost-effective alternative to conventional ownership, especially in situations where operation and maintenance costs associated with a project are of particular concern.

Equipment rental companies or service providers traditionally rent machines based on a “time use” basis, where the renter pays a daily, weekly, or monthly fee based on the amount of time that the renter uses the equipment. However, the traditional “time use” methods generally do not account for project-specific factors such as, for example, environmental conditions, abnormal equipment wear, equipment abuse, geographic location, loading conditions, equipment overuse, or any other such factor associated with equipment use. Often, damages and/or costs associated with these factors are difficult to accurately quantify after the equipment has been returned by the customer. Furthermore, these factors, if unaccounted for, may lead to premature wear, loss, or eventual failure of the equipment due to improper use prior to complete cost recovery by the equipment owner. As a result, equipment owners, particularly those in the rental equipment business, may have difficulty accurately and efficiently determining fees and costs associated with project-oriented equipment use, particularly in work machine environments.

One attempt for calculating a usage fee based on the type and amount of use of a piece of equipment is described in U.S. Patent Publication No. 2004/0176965 (hereafter referred to as the '965 publication) to Winch et al. The '965 publication describes an apparatus for calculating a usage fee for equipment including a monitoring means for monitoring the usage of the equipment, a comparing means to determine a predetermined depreciation level value, and a calculating means for calculating an equipment usage fee by combining the equipment usage data with the depreciation level value. The '965 publication also discloses a transmitting and controlling means for transmitting information to, and controlling the equipment from, a remote location.

Although the system of the '965 publication may provide a system for calculating a rental fee for a piece of equipment based on the usage and depreciation level, it still has some drawbacks. For example, because the system of the '965 publication calculates fees based solely on the actual use of a piece of equipment without regard to pre-use project-specific details (e.g., project scope, project budget, project schedule, type of work to be performed, etc.), accurate forecasting of the fees or costs of a particular project prior to the equipment use, based upon a preliminary analysis of the project, may be limited. As a result, the system of the '965 publication may do nothing to provide a customer with budget forecasts of equipment available to perform the project, while accounting for potentially high-cost or excessively harsh project conditions that may lead to excessive equipment wear and inflated maintenance costs. Thus, the '965 publication may lack a mechanism to efficiently and reliably determine the applicable fees and costs for the customer, prior to equipment use.

In addition, because the system of the '965 publication is directed exclusively to fee calculation for actual equipment usage, it may do nothing to provide a customer (e.g., renter, lesser, etc.) with one or more equipment options for performing the project. For example, in certain circumstances, during the planning and budgeting stages of a perspective job, a customer may only know certain specific details of a particular project such as schedule, location, scope of work, or other associated project-specific parameters. Thus, without knowing which equipment that a customer requires, conventional systems may lack the necessary functions to adequately and efficiently provide equipment options to the customer based on the project requirements.

The disclosed system and method for selling projects performable by a work machine are directed to overcoming one or more of the deficiencies set forth above.

### SUMMARY OF THE INVENTION

Systems and methods are disclosed for selling work machine projects. According to one embodiment, a method of selling projects performable by work machines is disclosed and may include receiving, at a processing device, one or more predefined parameters indicative of a proposed work project. The method may also include determining, based on the predefined parameters provided by a user, one or more equipment solutions for performing the project, using at least one work machine. The method may further include calculating a fee associated with the one or more equipment solutions based on a predetermined usage characteristic. The method may also include providing the at least one work machine associated with the determined equipment solution to the user. The method may further include remotely monitoring one or more operational aspects of the at least one work machine during operations of the work project.

According to another embodiment, the present disclosure is directed to a method for determining the price of a project performable by a work machine. The method may include determining a base price associated with a proposed project performable by a work machine requested by a user. The method may also include determining an overhead price in response to one or more predefined criteria supplied by the user. The method may further include calculating a pre-usage price of the proposed project based on the base price and the overhead price. The method may also include collecting operation data associated with the work machine while performing the proposed project. The method may further include adjusting the pre-usage price of the work machine, based on a deviation of an operational parameter of the work machine from the one or more predefined criteria of the work machine based on the collected operation data.

In accordance with yet another embodiment, the present disclosure is directed toward a system for selling projects performable by a work machine. The system may include a work machine including one or more monitoring devices configured to monitor one or more operational aspects of the work machine and a data collector in data communication with the one or more monitoring devices and configured to receive the one or more operational aspects of the work machine. The system may also include a processing device in data communication with the data collector and configured to receive one or more predefined parameters from a user indicative of a proposed project, determine an equipment solution for performing the project based on the predefined parameters wherein the solution includes using the work machine to perform the proposed project, and calculate a fee associated with the equipment solution based on a predetermined usage characteristic of the work machine.

According to another embodiment, the present disclosure is directed toward a system for selling work machine-related projects. The system may include a data processing system configured to receive a request from a user identifying a proposed project to be performed, the request including predefined parameters associated with the project. The data processing system may also be configured to analyze the predefined parameters and determine an equipment solution based on the analysis, wherein one equipment solution identifies a set of work machines to be used in performing the proposed project based on the predefined parameters. The data processing system may also be configured to determine a fee for the equipment solution based on the type of machine included in one set. The data processing system may further be configured to receive operation data from each of the work machines in the set that reflects actual operations of each of the work machines while performing the proposed project. The data processing system may also be configured to adjust the equipment solution fee based on the received operation data from one or more of the work machines in one set.

### BRIEF DESCRIPTION OF THE DRAWINGS

FIG. 1A illustrates an exemplary disclosed system for selling projects performable by a work machine consistent with certain disclosed embodiments;

FIG. 1B illustrated a schematic of an exemplary disclosed system for selling projects performable by a work machine consistent with certain disclosed embodiments;

FIG. 2 illustrates a flowchart depicting an exemplary disclosed method for selling projects performable by one or more work machines consistent with certain disclosed embodiments; and

FIG. 3 illustrates a flowchart depicting an exemplary disclosed method for determining price of a project performable by one or more work machines consistent with certain disclosed embodiments.

### DETAILED DESCRIPTION

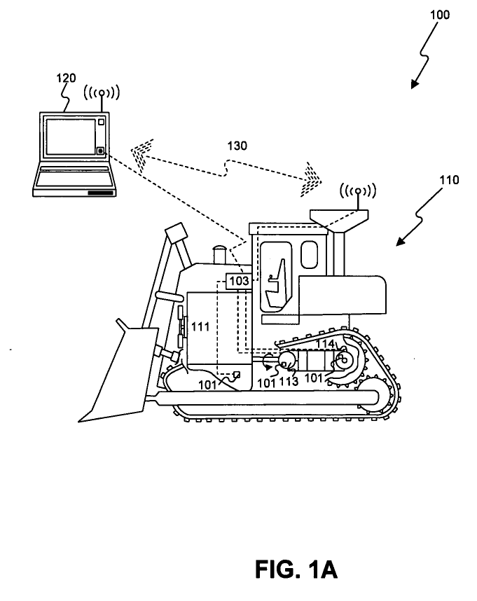

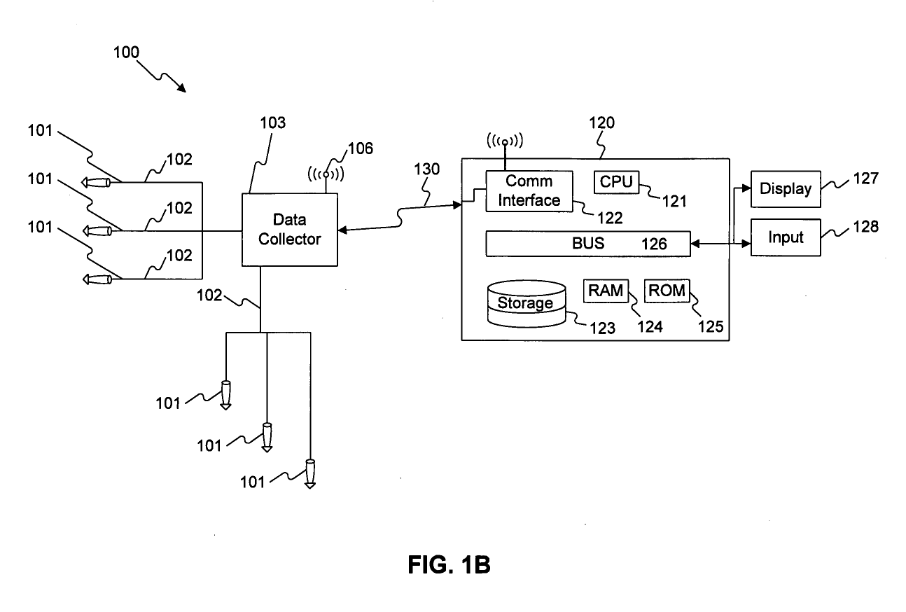

FIG. 1A illustrates an exemplary system 100 for selling projects performable by one or more work machines 110 (hereafter referred to as “system”) consistent with certain disclosed embodiments. System 100 may include one or more work machines 110 and a processing device 120. Each work machine 110 may include one or more monitoring devices 101 that are each configured to monitor an operational aspect of work machine 110 and a data collector 103. System 100 may be configured to receive project-specific information, provide one or more equipment solutions to a user, which may include one or more work machines 110 (or variety of different types of work machines) operable to complete the project, determine a price associated with each equipment solution, and adjust the price of the equipment solution based on the actual usage characteristics of the work machines 110 used in the solution. It is contemplated that additional and/or different components than those listed above may be included in system 100.

Work machine 110 may include a fixed or mobile machine configured to perform an operation associated with a user-defined project. Thus, work machine, as the term is used herein, refers to a fixed or mobile machine that performs some type of operation associated with a particular industry, such as mining, construction, farming, etc. and operates between or within work environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A work machine may be driven by a power source 111 that may include a combustion engine or an electric motor. The types of work machines listed above are exemplary and not intended to be limiting. It is contemplated that system 100 may implement any type of work machine. Accordingly, although FIG. 1A shows work machine 100 as a track-type tractor machine, work machine 110 may be any type of work machine operable to perform a particular function within the user-defined project environment.

In one embodiment, work machine 110 may include on-board data collection and communication equipment to monitor, collect, and/or transmit information associated with an operation of one or more components of work machine 100. For example, work machine 110 may include, among other things, one or more monitoring devices 101, such as sensors, electronic control modules, etc. (not shown), one or more data collector 103, one or more transceiver devices (not shown), and/or any other such components for monitoring, collecting, and communicating information associated with the operation of work machine 110. Each work machine 110 may also be configured to communicate information with off-board systems, such as a processing device 120, a back-end communication system (not shown), etc. The components described above are exemplary and not intended to be limiting. Accordingly, the disclosed embodiments contemplate work machine 110 including additional and/or different components than those listed above.

In one exemplary embodiment illustrated in FIG. 1B, one or more monitoring devices 101 may include detection devices, each of which may be configured to monitor an operational aspect of work machine 110. For example, monitoring devices 101 may include parameter sensitive devices configured to provide an output signal indicative of a particular parameter associated with an operation of work machine 110 and/or its constituent components. Monitoring devices 101 may include, for example, sensors (e.g., pressure, temperature, flow rate, etc.), electrical relays, circuit breakers, or any other such device configured to provide a signal indicative of an operational parameter of work machine 110. In one embodiment, monitoring device 101 may be operatively coupled to a particular component of work machine 110 to monitor the operation of that component. For example, one or more monitoring devices 101 may be associated with power source 111, a generator 113, an electric motor 114, a transmission (not shown), or any other such component of work machine 110 to monitor an operational aspect of a given component.

In addition, monitoring devices 101 may be configured to provide the monitored parameter data to one or more on-board systems internal to work machine 110. For example, each of monitoring devices 101 may include an input/output device configured to transmit the monitored parameter data to data collection components such as, for example, an electronic control unit of work machine 110, a data collector 103, a central data server (not shown) associated with work machine 110, or any other such device configured to receive parameter data. It is contemplated that monitoring devices 101 may transmit the parameter data automatically and/or in response to a request. Further, it is also contemplated that monitoring devices 101 may transmit parameter data in any of a variety of data formats such as, for example, analog, digital, or a combination of analog and digital formats.

Data collector 103 may be in data communication with monitoring devices 101 and may include various components configured to collect, transmit, and distribute parameter data monitored by monitoring devices 101 to one or more processing devices external to work machine 110. For example, data collector 103 may include a centralized data collector within work machine 110 to collect parameter data from one or more monitoring devices 101, transmit the parameter data to a processing device 120, or distribute the parameter data to other devices and/or components associated with an operation of work machine 110. Data collector 103 may include, for example, an electronic control unit, a status information device configured to transmit data to back-end systems, or any other such device operate to collect, transmit, and distribute parameter data.

In one embodiment, data collector 103 may include various hardware and/or software components that perform processes consistent with certain disclosed embodiments. For example, data collector 103 may include one or more central processing units (CPU) (not shown) for processing and analyzing parameter data, one or more computer-readable memory devices (not shown) for storing parameter data, and one or more input/output (I/O) devices (e.g., wireless transceiver 106, etc.) for communicating information to one or more off-board systems. It is contemplated that data collector 103 may include one or more executable programs that, when executed by the CPU, may further analyze parameter data collected from monitoring devices 101.

Data collector 103 may be communicatively coupled to data monitoring devices 101 via communication lines 102. Communication lines 102 may include electrical wires, twisted pair cables, optical fiber cables, wireless links such as infrared links, Bluetooth connections, satellite communication, or any other media known in the art for transmission of data information. Data information may be transmitted using an analog format, a digital format, a combination thereof, or any other format of data communication for communication of information over communication line 102.

Processing device 120 may include one or more hardware and/or software components that perform processes consistent with certain disclosed embodiments. For example, processing device 120 may include a central processing unit (CPU) 121, a communication interface 122, one or more storage devices 123, a random access memory (RAM) module 124, a read-only memory (ROM) module 125, a common interface bus 126, a display device 127, and/or an input device 128. Furthermore, processing device 120 may include executable programming code to perform various operations associated with user-defined parameters, operation parameters, or any other such data associated with work machine 110 and/or a project performable by work machine 110. Processing device 120 may be configured to transmit and/or receive parameters from a user or user-system (not shown), collect operation data from one or more work machines 110, analyze the collected data, and output the collected data in a pre-defined user-readable format. It is contemplated that processing device 120 may include additional and/or different component than those listed above. Moreover, the device listed are intended to be exemplary and non-limiting according to one embodiment.

Processing device 120 may be communicatively coupled to data collector 103 via communication link 130. Communication link 130 may be a network that provides communications between processing device 120 and data collector 103 associated with each work machine 110. For example, communication link 130 may communicatively couple one or more work machines 110 with processing device 120 across a wireless networking platform such as, for example, a satellite communication system. Alternatively and/or additionally, communication link 130 may include one or more broadband communication platforms appropriate for communicatively coupling one or more data collectors 103 associated with work machines 110 to processing device 120 such as, for example, cellular, Bluetooth, microwave, point-to-point wireless, point-to-multipoint wireless, multipoint-to-multipoint wireless, or any other appropriate communication platform for networking a number of components. Although communication link 130 is illustrated as a wireless communication link, it is contemplated that communication link 130 may include wireline networks such as, for example, Ethernet, fiber optic, waveguide, or any other type of wired communication network.

Processing device 120 may be communicatively coupled to data collector 103 and configured to receive one or more predefined parameters indicative of a project performable by work machine from a user or user-system. For example, processing device 120 may collect user-input parameters associated with a project performable by one or more work machines 110. User-input project parameters may include, for example, a job type (e.g., excavation, mining, hauling, land clearing, drilling, digging, etc.,) a geographical profile of the project area (e.g., acreage, terrain, environmental conditions, etc.), a timeline for project scheduling (e.g., operation times, duration of project, shift information), a preliminary determination of usage (e.g., predicted engine hours, miles to be traveled, weight of material to be hauled and/or excavated, number of machine operators, a list of registered users, etc.), warranty and insurance information (e.g., coverage amounts, equipment replacement costs, etc.), equipment budget (maximum equipment costs, etc.), and/or any other such preliminary project parameters. It is contemplated that the parameters listed above are exemplary and not intended to be limiting. Moreover, additional and/or different user-input parameters may be included without departing from the scope of the present disclosure.

Processing device 120 may also be configured to determine an equipment solution for performing the project based on the predefined and/or user-input parameters. An equipment solution may reflect a recommendation to complete a particular type of project using one or more work machines 110 of various types, sizes, quantities, capabilities, etc. that may be implemented to complete the particular project according to the predefined parameters. For example, for an excavation and mining project, an equipment solution may include one or more work machines 110 that may cooperate to complete a portion of the particular project such as, for example, one or more excavators, track-type tractors, dump trucks, and/or dozers. Work machines included as part of the equipment solution may be provided in varying quantities, based on the project requirements. For any particular project, multiple equipment solutions may be provided depending upon the predefined project parameters. Similarly, it is contemplated that for certain projects, only one equipment solution may be available based on the predefined project parameters.

Processing device 120 may further be configured to calculate a fee associated with the at least one equipment solution, based on predetermined and/or actual usage characteristics of work machine 110. For example, equipment solution pricing data and/or fees may be calculated for each type of work machine, based on the predefined usage characteristics defined by the project parameters. Upon completion of the project, the pricing data and fees may be updated to reflect the actual usage characteristics to include fee adjustments based upon the parameter data collected during the use of the work machines 110 associated with the equipment solution. These fee adjustments, if required, may be based on a number of criteria such as, for example, a depreciation costs associated with a particular use, a damage assessment based on a particular event occurrence, an overuse condition of the work machine, an operation of the machine outside of a geographical boundary, an unauthorized use of the machine by a non-contract user, or any other such criteria.

CPU 121 may be one or more processors that execute instructions and process data to perform one or more processes consistent with certain disclosed embodiments. For instance, CPU 121 may execute software that enables processing device 120 to request and/or receive operational data from one or more data collectors 103 of work machine 110. CPU 121 may also execute software that stores collected operational data in one or more storage devices 123. In addition, CPU 121 may execute software that enables processing device 120 to determine equipment solutions, calculate user fees, and analyze operation data collected from one or more work machines 110.

CPU 121 may be connected to a common information bus 126 that may be configured to provide a communication medium between one or more components associated with processing device 120. For example, common information bus 126 may include one or more components for communicating information to a plurality of devices.

A communication interface 122 may include one or more elements configured for two-way data communication between processing device 120 and off-board systems. For example, communication interface 122 may include one or more modulators, demodulators, multiplexers, demultiplexers, network communication devices, wireless devices, antennas, modems, or any other such devices configured to provide a two-way communication interface between processing device 120 and off-board systems or components.

One or more data storage devices 123 may include magnetic or optical data storage devices configured to store information, instructions, and/or software code used by CPU 121 of processing device 120. Storage devices 123 may include magnetic hard-drives, optical disc drives, floppy drives, or any other such information storing device. A random access memory (RAM) device 124 may include any dynamic storage device for storing information and instructions by CPU 121. RAM 124 also may be used for storing temporary variables or other intermediate information during execution of instructions to be executed by CPU 121. During operation, some or all portions of an operating system (not shown) are loaded into RAM 124. In addition, a read only memory (ROM) device 125 may include any static storage device for storing information and instructions by CPU 121.

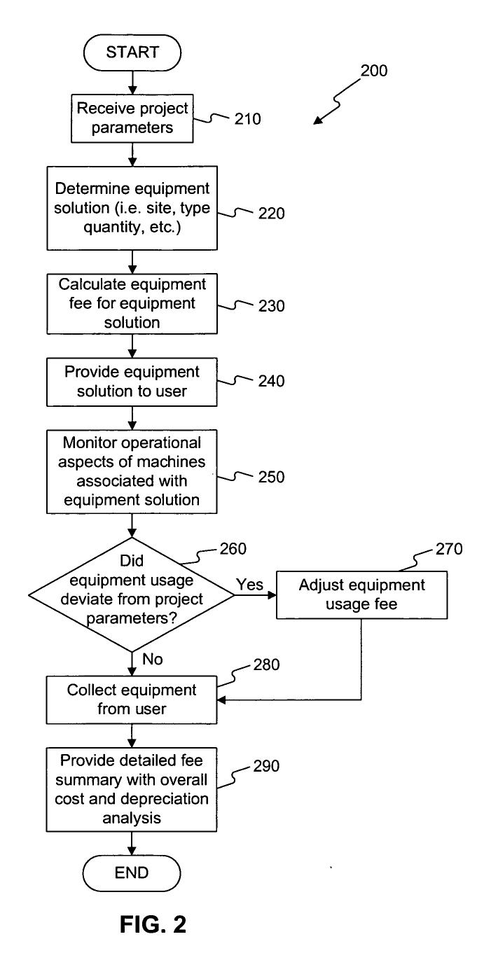

As explained, methods and systems consistent with the disclosed embodiments provide a platform for offering equipment solutions for projects performable by a work machine. FIG. 2 shows a flowchart 200 which illustrates a method for selling projects performable by a work machine, consistent with certain disclosed embodiments. As illustrated in FIG. 2, processing device 120 receives project parameters associated with a particular project to be performed by one or more work machines 110 from a user or user-system (Step 210). The project parameters may be input directly into processing device 120 using input device 128 or may alternatively be gathered from a variety of sources associated with a project definition such as, for example, a project management schedule, a request for proposal (RFP) submitted by a service provider, an internet request for bid, and/or any other method for collecting project parameters for a particular project. Project parameter types may include project activities (e.g., excavating, hauling, digging, etc.), budget projections (e.g., equipment budget, project activity budget, etc.), project schedule (e.g., duration of project, duration of each project activity of the project, projected work hours, etc.), geographic location and/or boundaries (e.g., city, latitude/longitude of site, etc.), environmental conditions, registered users of one or more work machines, or any other such parameter for describing a particular project. It is also contemplated that project parameter types may be prioritized such that system 100 may provide equipment recommendations in accordance with the user-defined priority. For example, if cost is indicated by a customer as a priority specification, system 100 may provide only those equipment solutions to the customer that minimize cost. Alternatively and/or additionally, if project schedule is indicated as a priority, system 100 may provide equipment solutions that can perform the project according to the user's scheduling requirements with less regard for cost implications.

Once one or more of the project parameters have been collected and/or stored, processing device 120 may determine one or more equipment solutions operable to perform the project, based on the project parameters (Step 220). Each equipment solution may include one or more work machines 110 operable to perform at least a portion of the project. For example, processing device 120 may determine, based on the project parameters, a certain number of work machines of different types that are required to complete a given project in a selected time frame. For any particular set of project parameters, one or more equipment solutions may exist to perform the project. It is also contemplated that processing device 120 may prioritize each equipment solution based on one or more priority conditions. For example, if equipment budget is a priority, processing device may include equipment solutions prioritized according to cost. Alternatively and/or additionally, if minimal environmental impact is a priority, processing device 120 may provide equipment solutions using more fuel efficient, cleaner work machines.

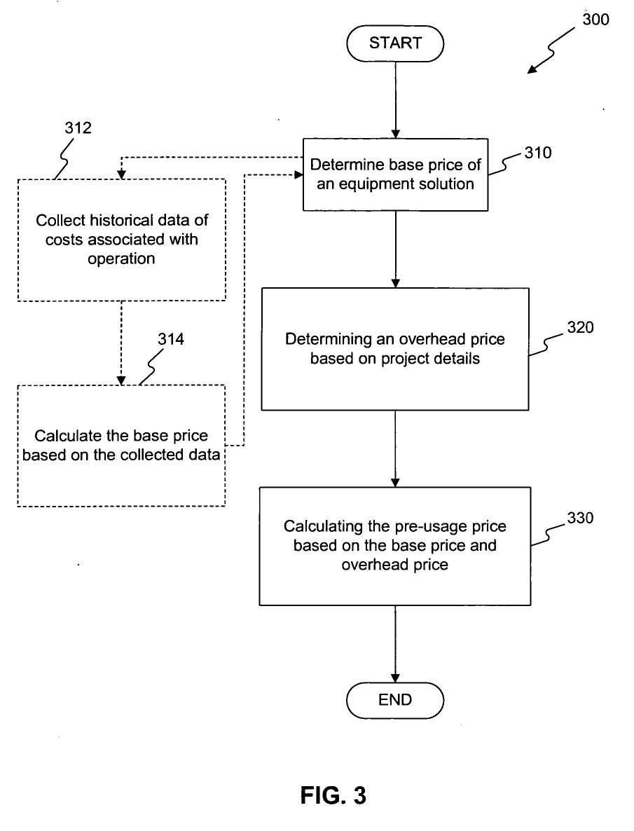

Upon determining one or more equipment solutions associated with a particular project, an equipment fee may be calculated for each equipment solution (Step 230). FIG. 3 illustrates an exemplary disclosed method 300 for calculating an equipment fee for equipment solutions associated with a project. The base price of each equipment solution may be calculated based on work machine type, rental period, depreciation value, historical data collected from previous uses of similar types of work machines, and/or any other method for valuating a work machine prior to use (Step 310). According to one embodiment, base price determination may be performed by collecting historical data from previous uses of the work machine (Step 312). The base price may then be calculated based on the historical data collected from previous operations (Step 314). For example, equipment solution base prices may be calculated by evaluating previous uses of each type of work machine and calculating the operation cost, depreciation value, and maintenance costs from the previous uses. Thus, the fees may be determined based on the historical data associated with each work machine of the equipment solution. Once the base price has been established for the equipment solution, overhead price may be calculated based on the project parameters (Step 320). For example, if the project parameters indicate that the machine will be operated in an large geographical area, or the machines will be transported between geographical areas, a fee associated with this activity may be calculated. The overhead price is then combined with the base price of the equipment solution to establish the pre-usage price of the equipment solution for the project (Step 330).

Referring back to FIG. 2, processing system 120 may provide the equipment solution for use within the parameters of the particular project to the user (e.g., customer, lessee, etc.) (Step 240). In one exemplary embodiment, it is contemplated that providing the equipment solution to the user may include providing each registered operator of each of the work machines used in the solution a unique key for operating a respective work machine. This enables data processing system 120 to monitor and track the use of the machine and generate statistical data used in assessing the machines'use during operations.

Once the project commences, data processing device 120 may receive one or more operational aspects of each work machine 110 included as part of the equipment solution from the data collector 103 in each machine (Step 250). For example, data collector 103 in each machine 110 may collect operation parameters from one or more monitoring devices 101, and store, analyze, and/or transmit the operation parameters (including any analysis data) to processing device 120. Processing device 120 may, in turn, collect the operation parameters from data collector 103 in “real-time” via communication link 130. Alternatively and/or additionally, processing device 120 may collect the operation parameters from data collector 103 at predetermined intervals (e.g., hourly, daily, weekly, monthly, etc.) and/or at the end of the project, when the equipment is collected.

Processing device 120 may analyze the operation data collected from each of work machines 110 and determine if the operation of any of work machines 110 used in the solution deviates from the project parameters (Step 260). If one or more work machines 110 deviates from the predefined project parameters (Step 260: Yes), data processing system 120 may execute a process that adjusts the usage fee based on the particular deviation (Step 270). For example, if the project parameters indicate that the machine will be operated within a certain geographic area, and the operation data indicates that the machine was operated outside of the geographic area defined by the predefined project parameters, a usage fee may be included to reflect this deviation. Furthermore, it is contemplated that certain threshold levels may be defined within processing device to determine an appropriate fee level for one or more types of deviation activities. For example, a load sensor may monitor the loading capacity of the machine. If the sensor indicated that the load exceeded a certain predefined capacity, indicating potential abuse or overuse of the work machine, a fee may be assessed according to the terms of the rental agreement. Further, excessive use of a machine may cause adjustments to the usage fee. For instance, a work machine 110 that has been operated at engine speeds beyond a threshold limit may be assessed a larger fee. In another embodiment, data processing system 120 may adjust the usage fee based on depreciation values of the machines. Thus, after analyzing the operation data for a given machine, processing system 120 may determine that the value of the machine has depreciated below normal values for the contracted use of the machine.

In another embodiment, credit may be given to the user or operations of work machine 110 that reflect less use from that determined in the solution. Thus if a work machine 110 was only used half of its estimated use, processing system 120 may apply a credit to the usage fee for the solution.

Alternatively, if processing device 120 determines that equipment usage does not deviate from the predefined project parameters during the course of the project (Step 360: No), then the equipment may be collected from the user, without requiring the adjustment of fees or calculation of additional fees (Step 280).

In one exemplary embodiment, processing device 120 may provide a detailed fee summary including overall associated costs and depreciation analysis to the user of the equipment solution (e.g., customer, lessee, etc.) (Step 290). This detailed report may include pre-usage fees, monitored usage fees and event conditions, and/or post-usage fees associated with maintenance analysis. In addition, the report may provide the user and/or owner of work machines and/or equipment solutions with detailed cost, fee, and usage analysis, including detailed operator statistics for each registered user of the work machine. Furthermore, processing device 120 may store the report and analysis data in storage device 230 for future retrieval and analysis.

### INDUSTRIAL APPLICABILITY

The disclosed system and method for selling projects in a work machine environment may be applicable to any situation in which it may be desirable to sell the services of a particular piece of equipment. Specifically, the disclosed system and method for selling projects in a work machine environment may provide a more cost effective, accurate, and equitable alternative to the conventional methods of equipment sale, lease, or rent.

The system for selling projects in a work machine environment described above enables equipment owners and/or rental agencies to sell services associated with one or more work machines 110 based on a project specification and subsequent use of the work machine, as opposed to the conventional “time-use” methods. The methods and systems consistent with the disclosed embodiments may provide a more accurate and realistic assessment of the costs associated with the use of the work machine, thereby ensuring appropriate cost recovery with each subsequent use of work machine 110.

The disclosed system may reduce the maintenance and repair costs incurred during the use of the work machines, because each work machine in the equipment solution may be remotely monitored by the work machine owner. Not only may this ensure proper fee calculation upon completion of the project, but any fault or abnormal event may be measured without having to perform manual inspections, thereby facilitating the efficient and quick repair, maintenance, or replacement of the work machine. As a result, maintenance personnel can more efficiently isolate any potential problems without having to perform detailed inspections or unnecessary analysis.

In contrast to conventional “time-use” systems of equipment rental or lease which do not provide significant flexibility with respect to project specific uses, the presently disclosed system is configured to receive project specific information from a user and provide one or more equipment solutions based on the actual project parameters. This may enable a user of the system to more efficiently plan, schedule, and budget for project costs by receiving one or more equipment solutions prior to commencement of the project. Furthermore, several equipment solutions for the same project may be provided by prioritizing various parameters according to the impact on important project benchmarks (i.e., cost reduction, scheduling, duration, fuel economy, environmental impact, etc.), which may offer customers a more flexible and comprehensive solution than conventional fee calculation systems.

Furthermore, because one or more equipment solutions are automatically provided by the system based on the project parameters specified by the user, much of the project analysis and cost determination required on the part of the customer may be reduced or eliminated. In contrast with conventional equipment rental or lease methods, a user of the presently disclosed system may not require any knowledge of equipment specifications and/or capabilities. As a result, costs associated with pre-project analysis and equipment planning may be significantly reduced or eliminated. Thus, a user may simply specify to a business entity employing the disclosed embodiments the type of job or task requested (e.g., removing X square feet of earth.) In turn, processing system 120 may offer to the user an equipment solution that identifies the number and type of work machines required to perform one job in a given time frame. In other embodiments, processing system 120 may offer alternative solutions that reflect how one job can be done quicker, etc. using more machines, different types of machines, etc. and an associated cost for the solution(s).

It will be apparent to those skilled in the art that various modifications and variations can be made to the disclosed method and system for selling projects in a work machine environment. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method of selling projects performable by work machines, comprising:
receiving, at a processing device, one or more predefined parameters indicative of a proposed work project;
determining, based on the predefined parameters provided by a user, one or more equipment solutions for performing the project using at least one work machine;
calculating a fee associated with the one or more equipment solutions based on a predetermined usage characteristic;
providing the at least one work machine associated with the determined equipment solution to the user; and
remotely monitoring one or more operational aspects of the at least one work machine during operations of the work project.

2. The method of claim 1, further including adjusting the fee based on the monitored operational aspects of the work machine.

3. The method of claim 2, wherein adjusting the fee includes adjusting the fee based on a deviation from the one or more predefined parameters.

4. The method of claim 1, wherein providing the at least one work machine includes providing a registered operator of one work machine a unique key for operating the at least one work machine.

5. The method of claim 1, wherein determining the equipment solution includes determining a type of work machine required to perform the project based on the predefined parameters.

6. The method of claim 1, wherein the one or more predefined parameters includes a length of time associated with the project.

7. The method of claim 1, wherein the one or more predefined parameters includes a location of the project.

8. The method of claim 1, wherein the one or more predefined parameters includes an equipment budget associated with the project.

9. The method of claim 1, wherein the predetermined usage characteristic includes a cost associated with the use of the at least one work machine to perform a project similar to the proposed work project based on historical data for at least one work machine.

10. A method for determining the price of a project performable by a work machine, comprising;
determining a base price associated with a proposed project performable by a work machine requested by a user;
determining an overhead price in response to one or more predefined criteria supplied by the user;
calculating a pre-usage price of the proposed project based on the base price and the overhead price;
collecting operation data associated with the work machine while performing the proposed project; and
adjusting the pre-usage price of the work machine, based on a deviation of an operational parameter of the work machine from the one or more predefined criteria of the work machine based on the collected operation data.

11. The method of claim 10, wherein determining the base price associated with the proposed project includes:
collecting historical data indicative of a cost associated with a previous operation of the work machine similar to the proposed project; and
calculating the base price of the project based on the collected historical data and one or more specifications of the proposed project.

12. The method of claim 11, wherein collecting historical data indicative of the cost includes collecting historical data indicative of actual usage costs associated with the operation of the work machine during a project similar to the proposed project.

13. The method of claim 11, wherein collecting historical data indicative of the cost includes collecting historical data indicative of maintenance costs associated with the operation of the work machine during a project similar to the proposed project.

14. The method of claim 11, wherein collecting historical data indicative of the cost includes collecting historical data indicative of a depreciation value of the work machine caused by operations of the work machine during a project similar to the proposed project.

15. The method of claim 10, wherein the predefined criteria includes a location of the work machine.

16. The method of claim 10, wherein the predefined criteria includes a predetermined operation time of the work machine.

17. The method of claim 10, wherein the predefined criteria includes a load threshold limit of the work machine.

18. A system for selling projects performable by a work machine, comprising:
a work machine including:
one or more monitoring devices configured to monitor one or more operational aspects of the work machine; and
a data collector in data communication with the one or more monitoring devices and configured to receive the one or more operational aspects of the work machine; and
a processing device in data communication with the data collector and configured to:
receive one or more predefined parameters from a user indicative of a proposed project;
determine an equipment solution for performing the project based on the predefined parameters wherein the solution includes using the work machine to perform the proposed project; and
calculate a fee associated with the equipment solution based on a predetermined usage characteristic of the work machine.

19. The system of claim 18, wherein calculating the fee associated with the at least one equipment solutions further includes adjusting the fee if the one or more operational aspects of the at least one work machine exceed a predefined threshold during operations of the proposed project.

20. The system of claim 19, wherein the processing device is configured to adjust the fee based on a deviation from one or more predefined parameters by a work machine during operations of the proposed project.

21. The system of claim 20, wherein the one or more predefined parameters includes a length of time associated with the proposed project.

22. The system of claim 20, wherein the one or more predefined parameters includes a location of the proposed project.

23. The system of claim 20, wherein the one or more predefined parameters includes an equipment budget associated with the proposed project.

24. A system for selling work machine-related projects, including;
a data processing system configured to:
receive a request from a user identifying a proposed project to be performed, the request including predefined parameters associated with the project,
analyze the predefined parameters,
determine an equipment solution based on the analysis, wherein one equipment solution identifies a set of work machines to be used in performing the proposed project based on the predefined parameters,
determine a fee for the equipment solution based on the type of machine included in one set,
receive operation data from each of the work machines in the set that reflects actual operations of each of the work machines while performing the proposed project, and
adjust the equipment solution fee based on the received operation data for one or more of the work machines in one set.
